(19) United States
(12) Patent Application Publication
(10) Pub. No.: US 2026/0180047 A1
(43) Pub. Date: Jun. 25, 2026

(54) METHOD AND APPARATUS FOR CONTROLLING CHARGING AND DISCHARGING OF BATTERY

(71) Applicant: Hanwha Solutions Corporation, Seoul (KR)

(72) Inventor: Min Seok PARK, Seoul (KR)

(73) Assignee: Hanwha Solutions Corporation, Seoul (KR)

(21) Appl. No.: 19/417,529

(22) Filed: Dec. 12, 2025

(30) Foreign Application Priority Data
Dec. 19, 2024 (KR) 10-2024-0190854

(51) Int. Cl. H01M 10/44; G06Q 10/04; G06Q 10/0631; G06Q 50/06; H02J 3/00

(52) U.S. Cl. CPC H01M 10/44; G06Q 10/04; G06Q 10/06315; G06Q 50/06; H02J 3/004

(57) ABSTRACT

A method of controlling charging and discharging of a battery includes obtaining information about a rate plan to be analyzed, extracting time-slot-based rate information about the rate plan to be analyzed based on detailed information about the rate plan to be analyzed, generating a plurality of groups into which a plurality of time periods included in a day are classified, based on the time-slot-based rate information, and controlling the charging and discharging of the battery based on the plurality of groups and a current charge amount of the battery.

### CROSS-REFERENCE TO RELATED APPLICATION

This application is based on and claims priority under 35 U.S.C. § 119 to Korean Patent Application No. 10-2024-0190854, filed on Dec. 19, 2024, in the Korean Intellectual Property Office, the disclosure of which is incorporated by reference herein in its entirety.

### BACKGROUND

### 1. Field

The disclosure relates to a method and apparatus for controlling charging and discharging of a battery based on rate plan information.

### 2. Description of the Related Art

A time-slot-based rate plan is a type of rate plan provided by an energy supply company, which may refer to a rate plan in which the unit price of energy varies depending on the time slot during which the user uses energy.

In more detail, the energy supply company offering the time-slot-based rate plan may classify multiple time slots within a day based on energy demand and form a plurality of groups based on the classified time slots to set different rates for each group. At this time, the multiple groups may include on-peak, partial peak, and off-peak times.

A user may reduce electricity charge by optimizing their electricity usage time by considering different rates for on-peak, partial-peak, and off-peak times.

The background technology described above is technical information that the inventor possessed for the purpose of deriving the disclosure or acquired in the process of deriving the disclosure, and cannot necessarily be considered as publicly known technology disclosed to the general public prior to the application for the disclosure.

### SUMMARY

The technical problem that the disclosure seeks to solve is to provide a method and apparatus for controlling charging and discharging of a battery. The disclosure may provide a method and apparatus for controlling charging and discharging of a battery based on time-slot-based rate information about a time-slot-based rate plan used by a user.

The problems to be solved by the disclosure are not limited to the problems mentioned above, and other problems and advantages of the disclosure that are not mentioned can be understood through the following description and will be more clearly understood through embodiments of the disclosure. In addition, it will be appreciated that the problems and advantages to be solved by the disclosure may be realized by the means and combinations thereof indicated in the patent claims.

As a technical means for achieving the above-described technical task, a first aspect of the disclosure may provide a method of controlling charging and discharging of a battery, the method including obtaining information about a rate plan to be analyzed, extracting time-slot-based rate information about the rate plan to be analyzed based on detailed information about the rate plan to be analyzed, generating a plurality of groups which are distinguishable from each other and correspond to a plurality of time periods, based on the time-slot-based rate information, and controlling the charging and discharging of the battery based on the plurality of groups and a current charge amount of the battery.

A second aspect of the disclosure may provide an energy management system including a processor configured to obtain information about a rate plan to be analyzed, extract time-slot-based rate information about the rate plan to be analyzed based on detailed information about the rate plan to be analyzed, generate a plurality of groups which are distinguishable from each other and correspond to a plurality of time periods, based on the time-slot-based rate information, and control charging and discharging of a battery based on the plurality of groups and a current charge amount of the battery.

A third aspect of the disclosure may provide a computer-readable recording medium having recorded thereon a program to cause a computer to execute the method of the first aspect.

Other aspects, features, and advantages other than those described above will become apparent from the following drawings, claims, and detailed description of the disclosure.

### BRIEF DESCRIPTION OF THE DRAWINGS

These and/or other aspects will become apparent and more readily appreciated from the following description of the embodiments, taken in conjunction with the accompanying drawings in which:

FIG. 1 is an example diagram for schematically describing a power supply system;

FIG. 2 is a diagram illustrating an energy management system according to an embodiment;

FIG. 3 is a flowchart illustrating a method by which an energy management system according to an embodiment controls charging and discharging of a battery;

FIG. 4 is a diagram illustrating a method by which an energy management system according to an embodiment obtains information about a rate plan to be analyzed;

FIG. 5 is a diagram illustrating a method by which an energy management system according to an embodiment generates a plurality of groups;

FIG. 6 is a diagram illustrating a method by which an energy management system according to an embodiment predicts photovoltaic generation amount and load consumption amount;

FIG. 7 is a diagram illustrating a method by which an energy management system according to an embodiment controls charging and discharging of a battery;

FIG. 8 is a diagram illustrating an energy management system according to an embodiment controlling charging and discharging of a battery; and

FIG. 9 is a diagram illustrating an interface that an energy management system according to an embodiment may provide.

### DETAILED DESCRIPTION

The advantages and features of the disclosure and the methods for achieving them will become clear with reference to the embodiments described in detail together with the accompanying drawings. However, the disclosure is not limited to the embodiments presented below, but may be implemented in various different forms, and should be understood to include all transformations, equivalents, or substitutes included in the spirit and technical scope of the disclosure. The embodiments presented below are provided to ensure that the disclosure of the invention is complete and to fully inform those skilled in the art of the scope of the disclosure. In describing the disclosure, if it is determined that a detailed description of a related known technology may obscure the gist of the disclosure, the detailed description is omitted.

The terminology used in this application is for the purpose of describing specific embodiments only and is not intended to limit the disclosure. Singular expressions include plural expressions unless the context clearly indicates otherwise. In this application, terms such as “include” or “have” are intended to specify the presence of a feature, number, step, operation, component, part or combination thereof described in the specification, but should be understood not to exclude in advance the possibility of the presence or addition of one or more other features, numbers, steps, operations, components, parts or combinations thereof.

Some embodiments of the disclosure may be represented by functional block configurations and various processing steps. Some or all of these functional blocks may be implemented with any number of hardware and/or software configurations that perform specific functions. For example, the functional blocks of the disclosure may be implemented by one or more microprocessors or by circuit configurations for a given function. In addition, for example, the functional blocks of the disclosure may be implemented in various programming or scripting languages. Functional blocks may be implemented as algorithms that run on one or more processors. In addition, the disclosure may employ conventional techniques for electronic environment setting, signal processing, and/or data processing. Terms such as “mechanism,” “element,” “means,” and “composition” may be used broadly and are not limited to mechanical and physical configurations.

In addition, the connecting lines or connecting members between components depicted in the drawings are merely example representations of functional connections and/or physical or circuit connections. In an actual device, connections between components may be represented by various functional, physical, or circuit connections that may be replaced or added.

Hereinafter, the disclosure will be described in detail with reference to the attached drawings.

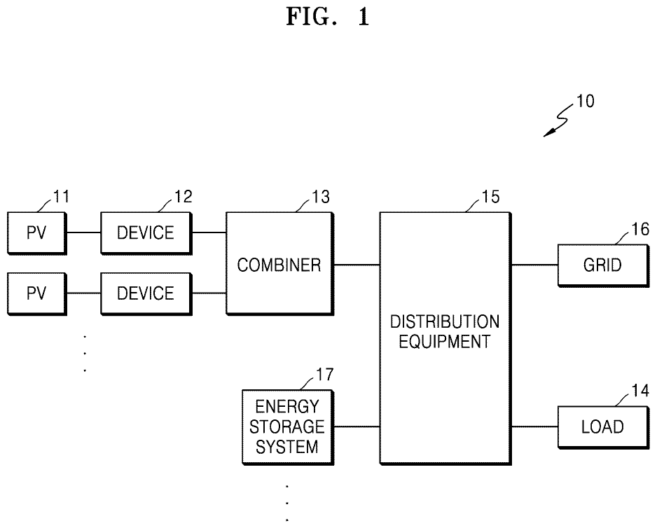

FIG. 1 is an example diagram for schematically describing a power supply system.

Referring to FIG. 1, a power supply system 10 may include a photovoltaic module 11, a device 12, a load 14, and/or distribution equipment 15. The power supply system 10 may be connected to an external power grid 16.

At least one photovoltaic module 11 may be installed on the roof or exterior wall of a building to generate power. A plurality of photovoltaic modules 11 may be connected to form a photovoltaic module array.

The photovoltaic module 11 may be connected to the device 12. For example, at least one device 12 may be connected to each photovoltaic module 11. As an example, in case that one device 12 is connected to each photovoltaic module 11, the number of devices 12 configuring the power supply system 10 may be equal to the number of photovoltaic modules 11.

The device 12 may be a power conditioning system (PCS) or power conversion system that performs power conversion for power generated from the photovoltaic module 11. For example, the device 12 may perform a certain conversion on the power generated from the photovoltaic module 11 and supply the converted power to other components of the power supply system 10 (e.g., the power grid 16 and/or the load 14, etc.).

In some embodiments, the device 12 may be module-level power electronics (MLPE). For example, the device 12 may be an optimizer or a micro-inverter (MI).

As an example, in case that the device 12 is an optimizer, the device 12 may regulate the power produced from the photovoltaic module 11 and output the regulated power to an inverter (e.g., a string inverter). Current converted by an inverter (e.g., direct current converted into alternating current) may be output to the power grid 16 or the load 14.

In some embodiments, in case that the device 12 is an MI, the device 12 may convert power generated from the photovoltaic module 11 (e.g., conversion of direct current into alternating current). The current converted by the device 12 may be output to the power grid 16 or the load 14.

When necessary, the power supply system 10 may further include a combiner 13. At least some of the devices 12 may be connected to the distribution equipment 15 via the combiner 13. For example, power output from a plurality of devices 12 may be combined into one output in the combiner 13 and supplied to the distribution equipment 15.

For example, the device 12 and the distribution equipment 15 may also be connected by a power path that does not include the combiner 13, and at least one device 12 may be connected to the distribution equipment 15 by a power path that does not include the combiner 13, and at least one other device 12 may be connected to the distribution equipment 15 via the combiner 13.

The combiner 13 may perform control on the voltage, current, and/or power output from the device 12 according to the power supply status of the photovoltaic module 11, the device 12, and/or the power grid 16, and may set an operating mode of the combiner 13 to a diagnosis mode or an operation mode, etc.

In some embodiments, the combiner 13 may include an energy management system (EMS) that controls an operation of the combiner 13. The EMS may perform control on the voltage, current, and/or power supplied to the combiner 13 or output from the combiner 13 according to the power supply status of the photovoltaic module 11, the device 12 and/or the power grid 16, and may set the operating mode of the combiner 13 to a diagnosis mode or an operation mode, etc.

The load 14 refers to an object that is installed in an electric power consumer, such as a house, commercial facility, or factory, and operates by receiving at least one of energy generated by the photovoltaic module 11, energy stored in an energy storage system 17, and/or energy supplied from the power grid 16. For example, in case that the electric power consumer receiving power is a house, the load 14 may include home appliances, such as a washing machine, a refrigerator, or a television (TV).

The power grid 16 may include an infrastructure system for generating, transmitting, and distributing power. For example, the power grid 16 may include infrastructure systems, such as power plants, substations, and power lines. For example, the power grid 16 may transmit electric energy generated by the power plant to the power supply system 10 or transmit surplus power generated by the power supply system 10 to the outside of the power supply system 10.

For example, commercial power transmitted from the power grid 16 through a power pole may be supplied to an electric power consumer through a transformer. For example, the power supply system 10 may also be implemented as an off-grid system that is not connected to the power grid 16.

For example, the power supply system 10 may further include at least one energy storage system 17. When necessary, the power supply system 10 may include a plurality of energy storage systems 17. The energy storage system 17 may receive and store power generated by the photovoltaic module 11 and/or power transmitted from the power grid 16. The energy storage system 17 may efficiently supply power by storing the power and supplying the power to the load 14 when the load 14 needs power.

The energy storage system 17 may include a battery that stores power and a power conversion module. The battery may be provided with a battery management system (BMS) that monitors the state-of-charge (SOC), state-of-health (SOH), voltage, and/or current of the battery, performs diagnostics on the battery, and performs safety functions such as current cutoff.

In some embodiments, the power conversion module may be a PCS that performs conversion between battery-side power and the opposite-side power. For example, the PCS may perform conversion between battery-side direct current and the opposite-side alternating current. As an example, the PCS may include a bidirectional direct current (DC)-DC converter that is connected to a battery and converts voltage, and a bidirectional inverter that connects the DC-DC converter to the outside of the energy storage system 17.

In some embodiments, the energy storage system 17 may further include an EMS that controls an operation of the energy storage system 17. The EMS may perform control on the voltage, current, and/or power supplied to the energy storage system 17 or output from the energy storage system 17 according to the power supply status of the battery and/or the power grid 16, and may set the operating mode of the energy storage system 17 to a diagnosis mode or an operation mode, etc.

When necessary, an EMS coupled to a certain component of the power supply system 10 may not only control an operation of the certain component, but may also further control operations of other components of the power supply system 10. For example, an EMS coupled to the combiner 13 or an EMS coupled to the energy storage system 17 may control both the operation of the combiner 13 and the operation of the energy storage system 17.

For example, the distribution equipment 15 may provide electrical connections between the components of the power supply system 10 and may control the power flow of the power supply system 10. For example, the distribution equipment 15 may electrically connect the photovoltaic module 11 to the load 14. As an example, the distribution equipment 15 may be connected to the device 12 connected to the photovoltaic module 11 to electrically connect the photovoltaic module 11 to the load 14. When necessary, the distribution equipment 15 may be further connected to at least one of the energy storage system 17 and the power grid 16.

For example, the distribution equipment 15 may be a distribution panel that distributes power within the power supply system 10. As an example, the distribution equipment 15 may be a master service panel (MSP) that distributes power generated by the photovoltaic module 11 to the load 14 or the like.

In some embodiments, the distribution equipment 15 may be a main controller that performs power distribution within the power supply system 10 and controls each device 12. As an example, the main controller may include a switch, a circuit breaker, and a controller. The switch, the circuit breaker, and the controller may each be implemented as independent devices, or at least some of the switch, the circuit breaker, and the controller may be included in a single device.

The main controller may include a switch that controls electrical connections between components connected to the main controller, such as the device 12 and the load 14. For example, the main controller may include a relay or power semiconductor that provides or blocks the electrical connection to the device 12 and/or the energy storage system 17 depending on an operating status of each component of the power supply system 10.

The main controller may perform a rapid shutdown to stop the power generation of the photovoltaic module 11 in an emergency situation such as an overcurrent occurrence within the power supply system 10. To this end, the main controller may include a circuit breaker that blocks the connection between the device 12 and the load 14.

The main controller may include a controller that generally controls the operation of the main controller. In addition to the main controller, the controller may control the operations of other components (e.g., the device 12 or the energy storage system 17) of the power supply system 10.

The controller may perform control on the voltage, current, and/or power output from each component or supplied to each component, according to the power supply status of the photovoltaic module 11, the device 12, the combiner 13, the load 14, the power grid 16, and/or the energy storage system 17. In some embodiments, the controller may set the operating mode of the main controller, the device 12, and/or the energy storage system 17 to a diagnostic mode or an operation mode, etc.

For example, the controller may control the photovoltaic module 11, the device 12, the combiner 13, and/or the energy storage system 17, based on the state of the power supply system 10. As an example, the controller may control other components of the power supply system 10 by allowing the main controller to communicate with other components (e.g., the device 12 or the like) of the power supply system 10. Communication between the main controller and other components of the power supply system 10 may be performed by using a power line communication (PLC) method, but is not limited thereto.

As an example, the controller may control the device 12 according to the power generation status of the photovoltaic module 11. For example, the main controller may receive a control command from a server that monitors the power generation status of the photovoltaic module 11, and the controller may control the device 12 according to the control command.

The main controller may supply power to at least some of the loads 14 in case that power supply from the power grid 16 is not smooth (e.g., in an off-grid situation). For example, in case that the power supply from the power grid 16 is not smooth, the main controller may preferentially supply power generated from the photovoltaic module 11 and/or power stored in the energy storage system 17 to a backup load having a relatively high need for a stable power supply.

For example, the power supply system 10 may further include an auxiliary power generation device (e.g., a diesel generator, etc.) that generates power in a separate manner other than photovoltaic generation. For example, the auxiliary power generation device may be further connected to the distribution equipment 15. In case that the backup load cannot be coped with only the photovoltaic module 11 and the energy storage system 17 due to environmental factors such as time slot or weather, the main controller may supply power generated by the auxiliary power generation device to the backup load.

The controller may be implemented by at least one processor. A processor may process commands in a computer program by performing basic arithmetic, logic, and input/output operations. Here, the commands may be provided from an internal memory of the main controller or from an external device. In some embodiments, the processor may be configured to control the overall operation of other components included in the main controller.

For example, the processor may perform at least some of the data analysis, processing, and result information generation for performing the above-described operations by using at least one of a machine learning, neural network, or deep learning algorithm as a rule-based or artificial intelligence algorithm. Examples of neural networks may include neural network models based on architectures such as a convolutional neural network (CNN), a deep neural network (DNN), and a recurrent neural network (RNN).

For example, the processor may also be implemented as an array of multiple logic gates, or may be implemented as a combination of a general-purpose microprocessor and a memory storing a program that may be executed on the microprocessor. For example, the processor may include a general-purpose processor, a central processing unit (CPU), a microprocessor, a digital signal processor (DSP), a controller, a microcontroller, a state machine, or the like.

In some environments, the processor may include an application-specific integrated circuit (ASIC), a programmable logic device (PLD), a field-programmable gate array (FPGA), or the like. For example, the processor may refer to a combination of processing devices, such as a combination of a DSP and a microprocessor, a combination of a plurality of microprocessors, a combination of one or more microprocessors coupled to a DSP core, or any combinations of such other configurations.

The power supply system 10 may be implemented in various forms by combining at least some of the components described above.

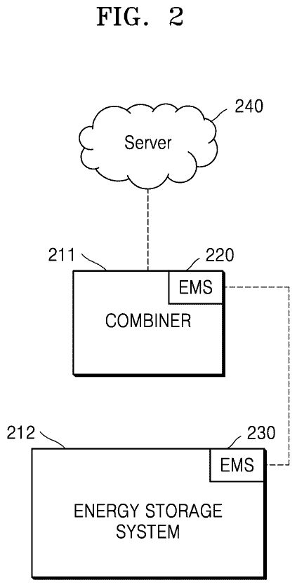

FIG. 2 is a diagram illustrating an EMS according to an embodiment.

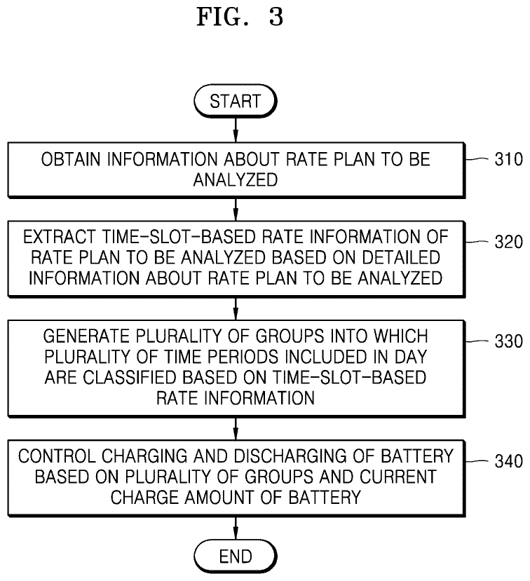

Hereinafter, a device capable of implementing a method to be described below with reference to FIGS. 3 to 6 is referred to as an energy management system 220 or 230.

Referring to FIG. 2, a portion of a photovoltaic generation system including an EMS according to an embodiment is illustrated. Referring to FIG. 2, a combiner 211, an energy storage system 212, and a server 240 are illustrated.

The combiner 211 of FIG. 2 may be the combiner 211 described above with reference to FIG. 1. The combiner 211 may perform control on the voltage, current, and/or power output from a photovoltaic generation device according to the power supply status of the photovoltaic generation device, a load, and/or a grid. At this time, the combiner 211 may be an alternating current (AC) combiner 211 that performs control on the voltage, current, and/or power for AC power. For example, the combiner 211 may include an EMS 220 according to an embodiment.

Referring to FIG. 2, the server 240 is illustrated. The EMS 220 or 230 according to an embodiment may perform prediction using a machine learning model using the server 240. In an embodiment, the EMS 220 or 230 may use a machine learning model to predict photovoltaic generation amount and load consumption amount over a certain time period. At this time, the EMS 220 or 230 according to an embodiment may perform prediction using a machine learning model using the server 240.

For example, each EMS 220 or 230 may be connected to the server 240 in various ways. Referring to FIG. 2, it is illustrated that the EMS 220 included in the combiner 211 is directly connected to the server 240. In some embodiments, it is shown that the EMS 230 included in the energy storage system 212 is connected to the EMS 220 included in the combiner 211.

However, the EMS 230 included in the energy storage system 212 according to an embodiment may be directly connected to the server 240 (not shown). At this time, the EMS 220 included in the combiner 211 may be connected to an EMS 220 included in the energy storage system 212 (not shown). In another embodiment, each EMS 220 or 230 may be directly connected to the server 240 (not shown).

In summary, the way in which each EMS 220 or 230 is connected to the server 240 may vary and is not limited by FIG. 2 and/or the above.

In another embodiment, the EMS 220 or 230 may use its own processor to predict photovoltaic generation amount and load consumption amount over a certain time period.

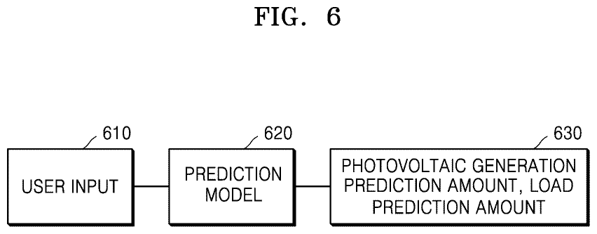

A detailed description of a method by which an EMS according to an embodiment predicts photovoltaic generation amount and load consumption amount over a certain time period is given below with reference to FIG. 6.

The energy storage system 212 of FIG. 2 may be the energy storage system 17 described above with reference to FIG. 1. The energy storage system 212 may include a battery, a converter, an inverter, and the EMS 230.

For example, an EMS 220 or 230 according to an embodiment may control charging and discharging of a battery. In an embodiment, the EMS 220 or 230 may control charging and discharging of a battery through a DSP that mechanically controls the battery.

For example, the EMS 220 or 230 may be connected to a DSP within the energy storage system 212 via a controller area network (CAN) to control charging and discharging of the battery. In some embodiments, the EMS 220 or 230 may be connected to a DSP within the energy storage system 212 via Modbus or Ethernet to control charging and discharging of a battery. In some embodiments, the EMS 220 or 230 may be physically connected to a DSP to control charging and discharging of a battery.

For example, the way in which the EMS 220 or 230 is connected to a DSP is not limited to the above description, and the EMS 220 or 230 may be connected to the DSP in various ways.

The EMS 220 or 230 according to an embodiment may be connected to each other by using Ethernet. For example, the server 240, the EMS 220 within the combiner 211, and the EMS 230 within the energy storage system 212 may be connected to each other via Ethernet. As an example, the EMS 220 included in the combiner 211, the EMS 230 included in the energy storage system 212, and the server 240 may perform communication using Ethernet to exchange information with each other.

The EMS 220 or 230 according to an embodiment may control charging and discharging of a battery included in the energy storage system 212. For example, a detailed description of a method by which the EMS 220 or 230 according to an embodiment controls charging and discharging of a battery is given below with reference to FIGS. 3 to 9.

As described above, the EMS 220 or 230 according to an embodiment may be included in the combiner 211 and/or the energy storage system 212. At this time, the EMS 220 or 230 may control charging and discharging of a battery.

In an embodiment, the EMS 220 or 230 may include a processor.

The processor may be implemented by using at least one of application-specific integrated circuits (ASICs), DSPs, digital signal processing devices (DSPDs), programmable logic devices (PLDs), FPGAs, controllers, micro-controllers, microprocessors, and other electrical units for performing functions.

The processor may be configured to control the overall operation of the EMS 220 or 230. For example, the processor may be configured to control at least some of the operations of the EMS 220 or 230.

As an example, the processor may obtain information about a rate plan to be analyzed, extract time-slot-based rate information about the rate plan to be analyzed based on detailed information about the rate plan to be analyzed, generate a plurality of groups into which a plurality of time periods included in a day are classified based on the time-slot-based rate information, and control charging and discharging of a battery based on the plurality of groups and a current charge amount of the battery.

In some embodiments, the processor may obtain information about a rate plan to be analyzed based on a user input and extract time-slot-based rate information from detailed information received from the server 240.

In some embodiments, the processor may extract time-slot-based rate information based on time-of-use (TOU) information included in detailed information.

In some embodiments, the processor may be configured to generate a plurality of groups by classifying a plurality of time slots included in a day into one of a first group, a second group, and a third group based on a sorting result of time-slot-based rate information.

In some embodiments, the processor may be configured to control charging and discharging of a battery by predicting the photovoltaic generation amount and load consumption amount over a certain time period based on input data including the previously performed photovoltaic power generation amount and the power amount previously consumed by the load.

In some embodiments, the processor may use a machine learning model to perform predictions.

In some embodiments, the processor may be configured to compare a value, obtained by deducting the predicted photovoltaic generation amount from the predicted load consumption amount, with the current charge amount of a battery, and, when the value obtained by deducting the predicted photovoltaic generation amount from the predicted load consumption amount exceeds the current charge amount of the battery, obtain a first cost incurred in charging the current battery through a grid and a second cost incurred in satisfying the predicted load consumption amount through the grid in the future to control the charging and discharging of the battery.

In some embodiments, the processor may be configured to compare a value, obtained by deducting the predicted photovoltaic generation amount from the predicted load consumption amount, with the current charge amount of a battery, and, when the value obtained by deducting the predicted photovoltaic generation amount from the predicted load consumption amount is equal to or less than the current charge amount of the battery, control the charging and discharging of the battery to satisfy the predicted load consumption amount through photovoltaic-generated energy and energy charged in the battery.

In some embodiments, the processor may be configured to control the battery based on a comparison result between the first cost and the second cost.

In some embodiments, the EMS 220 or 230 may be driven by a device (hereinafter, referred to as a driving device) that drives the EMS 220 or 230. For example, the driving device may include the processor described above with reference to FIG. 2.

For example, a detailed description of various operations of the EMS 220 or 230 that may be performed by a processor is given below with reference to FIGS. 3 to 9.

FIG. 3 is a flowchart illustrating a method by which an energy management system according to an embodiment controls charging and discharging of a battery.

In operation 310, a processor may obtain information about a rate plan to be analyzed.

In an embodiment, the processor may obtain information about the rate plan to be analyzed based on a user input. In this case, the rate plan to be analyzed may include a utility charge charged to the user.

For example, the utility charge may be a charge that the user pays to an energy supply company in return for consuming energy. For example, a utility charge may be a charge paid by the user to an energy company for consuming electrical energy using a grid. At this time, the utility charge may be charged based on a specific rate plan.

In operation 320, the processor may extract time-slot-based rate information about the rate plan to be analyzed based on detailed information about the rate plan to be analyzed.

In an embodiment, the processor may extract time-slot-based rate information from detailed information received from a server.

Detailed information according to an embodiment may mean data including various types of information about the rate plan to be analyzed. At this time, the detailed information may be provided by a utility charge information providing company. For example, the detailed information may refer to data that records the application conditions and unit prices of a specific rate plan applied to the rate plan to be analyzed. At this time, the detailed information may include TOU information.

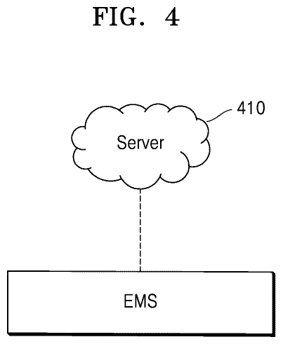

A detailed description of a method by which a processor according to an embodiment receives detailed information from a server is given below with reference to FIG. 4.

In an embodiment, the processor may extract time-slot-based rate information based on TOU information included in the detailed information.

The TOU information may refer to information about a particular rate plan provided when the particular rate plan is a time-slot-based rate plan. For example, the TOU information may include information about the season, day of the week, and time slot to which the particular charge plan corresponding to the time-slot-based rate plan is applied. That is, the TOU information may include the time-slot-based rate information.

The time-slot-based rate information may refer to information about rates that are charged differently depending on particular time slots. For example, the time-slot-based rate information may include the unit price of energy that applies during a particular time slot, such as 8:00 AM to 10:00 PM.

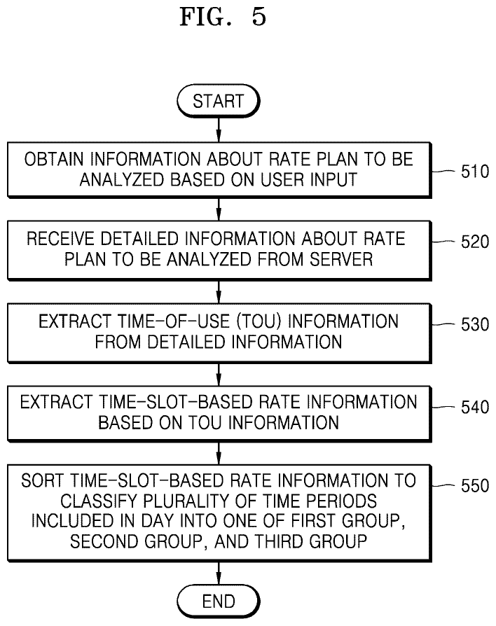

A detailed description of a method by which a processor according to an embodiment extracts time-slot-based rate information about a rate plan to be analyzed based on detailed information about the rate plan to be analyzed is given below with reference to FIG. 5.

In operation 330, the processor may be configured to generate a plurality of groups into which a plurality of time periods included in a day are classified based on the time-slot-based rate information.

In an embodiment, the processor may be configured to generate a plurality of groups by classifying a plurality of time slots included in a day into one of a first group, a second group, and a third group based on a sorting result of the time-slot-based rate information.

In an embodiment, the first group, the second group, and the third group may be on-peak time, partial-peak time, and off-peak time, respectively. For example, the processor may be configured to distinguish between the on-peak time, the partial-peak time, and the off-peak time based on the sorting result of the time-slot-based rate information, and designate the respective times as a first group, a second group, and a third group. At this time, the first group, the second group, and the third group may correspond to the on-peak time, the partial-peak time, and the off-peak time set by an energy supply company providing a rate plan to be analyzed, which is input by the user.

For example, a detailed description of a method by which a processor according to an embodiment generates a plurality of groups is given below with reference to FIG. 5.

In operation 340, the processor may be configured to control charging and discharging of a battery based on the plurality of groups and the current charge amount of the battery.

In an embodiment, the processor may predict a photovoltaic generation amount and a load consumption amount over a certain time period based on input data including the previously performed photovoltaic power generation amount and the power amount previously consumed by the load.

In an embodiment, the processor may perform prediction by a machine learning model.

In an embodiment, the processor may be configured to compare a value, obtained by deducting the predicted photovoltaic generation amount from the predicted load consumption amount, with the current charge amount of a battery, and, when the value obtained by deducting the predicted photovoltaic generation amount from the predicted load consumption amount exceeds the current charge amount of the battery, obtain a first cost incurred in charging the current battery through a grid and a second cost incurred in satisfying the predicted load consumption amount through the grid in the future to control the charging and discharging of the battery.

In an embodiment, the processor may be configured to compare a value, obtained by deducting the predicted photovoltaic generation amount from the predicted load consumption amount, with the current charge amount of a battery, and, when the value obtained by deducting the predicted photovoltaic generation amount from the predicted load consumption amount is equal to or less than the current charge amount of the battery, control the charging and discharging of the battery to satisfy the predicted load consumption amount through photovoltaic-generated energy and energy charged in the battery.

In an embodiment, the processor may be configured to control the battery based on a comparison result between the first cost and the second cost.

For example, a detailed description of a method by which a processor according to an embodiment performs prediction and controls charging and discharging of a battery is given below with reference to FIGS. 6 to 8.

FIG. 4 is a diagram illustrating a method by which an EMS according to an embodiment obtains information about a rate plan to be analyzed.

In an embodiment, a processor may obtain information about a rate plan to be analyzed.

As described above with reference to FIG. 2, the processor may be a processor included in an EMS and/or a driving device.

In an embodiment, the processor may obtain information about the rate plan to be analyzed based on a user input. For example, the processor may obtain the name of the rate plan input by the user as information about the rate plan to be analyzed.

In some embodiments, the processor may obtain information about the rate plan to be analyzed based on a particular rate plan selected by the user from a list of rate plans. For example, the processor may obtain the name of a particular rate plan selected by the user from a list of rate plans as information about the rate plan to be analyzed.

In an embodiment, the processor may be configured to provide a list of rate plans to the user. For example, the processor may download the list of rate plans from a particular website and provide the downloaded list of rate plans to the user. In some embodiments, the processor may be configured to provide a list of rate plans to the user by using a pre-generated list of rate plans.

In an embodiment, the processor may request a server 410 for detailed information about the rate plan to be analyzed. For example, the processor may request the server 410 of a utility charge information providing company for detailed information about the rate plan to be analyzed, which is input by the user. In some embodiments, the processor may receive the requested detailed information from the server 410 of the utility rate information providing company. In this case, the utility rate information providing company may be a company providing the detailed information.

As described above with reference to FIG. 3, the detailed information may mean data including various types of information about the rate plan to be analyzed. For example, the detailed information may refer to data that records the application conditions and unit prices of a particular rate plan applied to the rate plan to be analyzed. As an example, the detailed information may mean data that records the name of a particular rate plan and the conditions under which the corresponding rate plan applies. At this time, the conditions may include the season, day of the week, and time slot.

For example, the detailed information may include TOU information about a particular rate plan in case that the particular rate plan is a time-slot-based rate plan. For example, in case that the particular rate plan corresponds to a time-slot-based rate plan, the detailed information may include information about the season, day of the week, and time slot to which the corresponding rate plan is applied.

At this time, as described above with reference to FIG. 2, information about the time slot to which the rate plan is applied may be time-slot-based rate information. That is, in case that the particular rate plan corresponds to a time-slot-based rate plan, the detailed information may include TOU information and the time-slot-based rate information.

FIG. 5 is a diagram illustrating a method by which an EMS according to an embodiment generates a plurality of groups.

In operation 510, the processor may obtain information about a rate plan to be analyzed based on a user input.

In operation 520, the processor may receive detailed information about the rate plan to be analyzed from a server.

For example, detailed descriptions of operations 510 and 520 are the same as those described above with reference to FIG. 4 and thus are omitted.

In an embodiment, the processor may extract time-slot-based rate information about the rate plan to be analyzed based on detailed information about the rate plan to be analyzed.

In operation 530, the processor may extract TOU information from the detailed information. As described above with reference to FIG. 3, the TOU information may refer to information about a particular rate plan provided when the particular rate plan is a time-slot-based rate plan. As an example, the processor may extract the TOU information in a method of extracting information about rate plans corresponding to the time-slot-based rate plan from the detailed information including information about a plurality of rate plans. At this time, the TOU information may include time-slot-based rate information.

For example, the inclusion relation between the detailed information, the TOU information, and the time-slot-based rate information, and other detailed descriptions have been described above with reference to FIGS. 3 and 4, and thus are omitted.

In an embodiment, the processor may extract the time-slot-based rate information based on the TOU information included in the detailed information.

In operation 540, the processor may extract the time-slot-based rate information based on the TOU information.

As described above with reference to FIG. 3, the time-slot-based rate information may include information about rates charged differently depending on a particular time slot. For example, the time-slot-based rate information may be included in the TOU information. In an embodiment, the time-slot-based rate information may include the start time and end time for each time slot in which the unit price of energy changes, and the unit price of a corresponding time slot, which are extracted from the TOU information.

In an embodiment, the processor may be configured to generate a plurality of groups into which a plurality of time periods included in a day are classified based on the time-slot-based rate information. In an embodiment, the processor may be configured to generate a plurality of groups by classifying a plurality of time slots included in a day into one of a first group, a second group, and a third group based on a sorting result of the time-slot-based rate information. For example, the processor may list the unit prices included in the time-slot-based rate information in an ascending or descending order and generate a plurality of groups based on a result of the listing.

In operation 550, the processor may sort the time-slot-based rate information to classify the plurality of time slots included in a day into one of a first group, a second group, and a third group.

For example, the processor may sort time slots based on unit price. At this time, the processor may be configured to generate the plurality of groups by classifying the plurality of time slots included in a day into one of the first group, the second group, and the third group, based on a result of sorting the time slots based on the unit price.

As described above with reference to FIG. 3, the first group, the second group, and the third group may be the on-peak time, the partial-peak time, and the off-peak time, respectively. For example, the processor may divide the plurality of time slots in which the highest charge in the result of sorting the time slots based on the unit price is charged into the first group. At this time, the processor may divide the plurality of time slots, in which the lowest charge in the result of sorting the time slots based on the unit price is charged, into the third group. In some embodiments, the processor may divide the plurality of time slots in which the minimum or maximum charge in the result of sorting the time slots based on the unit price is not charged into the second group.

The processor according to an embodiment may generate and provide information about the first group, the second group, and the third group based on a user input, thereby increasing user convenience by enabling the user to easily obtain information about a charge per time slot.

FIG. 6 is a diagram illustrating a method by which an EMS according to an embodiment predicts photovoltaic generation amount and load consumption amount.

Hereinafter, the operation of the processor described with reference to FIG. 6 may be for controlling charging and discharging of a battery through a predicted photovoltaic generation prediction amount and a load prediction amount 630 predicted by considering the energy usage pattern of the user and the photovoltaic generation pattern of a photovoltaic generation system used by the user.

In an embodiment, the processor may predict the photovoltaic generation amount and the load consumption amount for a certain time period based on input data 610 including the previously performed photovoltaic power generation amount and the power amount previously consumed by the load. For example, the processor may predict the future photovoltaic generation amount and the future load consumption amount by inputting the photovoltaic generation amount generated in the past and the power amount consumed by the load in the past as the input data 610.

At this time, the previously performed photovoltaic power generation amount may include information about the amount of energy generated by using photovoltaic panels over a particular period of time. As an example, the previously performed photovoltaic power generation amount may include information about the amount of energy generated by photovoltaic panels on a particular day of the week and/or time of day.

The power amount consumed by the load in the past may include information about the amount of energy consumed by the load during a particular period of time. As an example, the power amount previously consumed may include information about the amount of energy consumed by the load on a particular day of the week and/or time of day. Accordingly, the processor may be configured to generate predictions that reflect the energy usage pattern of the user.

According to an embodiment, the processor may predict the future photovoltaic generation amount and the future load consumption amount as a result of performing the prediction. At this time, the processor may be configured to generate a load prediction amount and photovoltaic generation prediction amount 630 within 24 or 48 hours from the time of performing the prediction as a result of performing the prediction. However, the temporal range of the future photovoltaic generation amount and the future load consumption amount that the processor may predict is not limited by the above.

In an embodiment, the input data 610 may include time-slot-based rate information, a battery charge amount, and weather information, in addition to the previously performed photovoltaic power generation amount and the power amount previously consumed by the load in the past. At this time, the time-slot-based rate information may refer to the time-slot-based rate information described above with reference to FIGS. 2 to 6.

The battery charge amount may include the battery charge amount at the time of prediction. In some embodiments, the battery charge amount may include information about changes in the battery charge amount over a particular time period. For example, the battery charge amount may include information about the changes in the battery charge amount, which were measured over a past time period that is the same as the past time period as the previously performed photovoltaic power generation amount and the power amount consumed by the load in the past. The weather information may include hourly solar radiation amount, temperature, humidity, cloud amount, precipitation amount, sun altitude, season, or the like.

In an embodiment, the processor may perform predictions by using a machine learning model. For example, the processor may use a machine learning model to predict the photovoltaic generation prediction amount and the load prediction amount 630 based on the input data 610.

At this time, the machine learning model may include a model that learns data patterns based on input data and accordingly performs tasks such as prediction or classification. As an example, a prediction model 620 corresponding to the machine learning model may include a learning model based on at least one of various artificial neural network architectures such as a multilayer perceptron (MLP), a deep neural network (DNN), a convolutional neural network (CNN), or an autoencoder. In an embodiment, a history analysis model may be implemented by using, but is not limited to, XGBoost, Random Forest, Support Vector Machine (SVM), or a combination of at least two of these.

For example, the prediction process described with reference to FIG. 6 as described above with reference to FIG. 2 may be performed by using the server 240 illustrated in FIG. 2. However, the prediction process described above with reference to FIG. 6 is not necessarily performed by using the server 240. In another embodiment, the prediction process described above with reference to FIG. 6 may be performed by a processor included in an EMS.

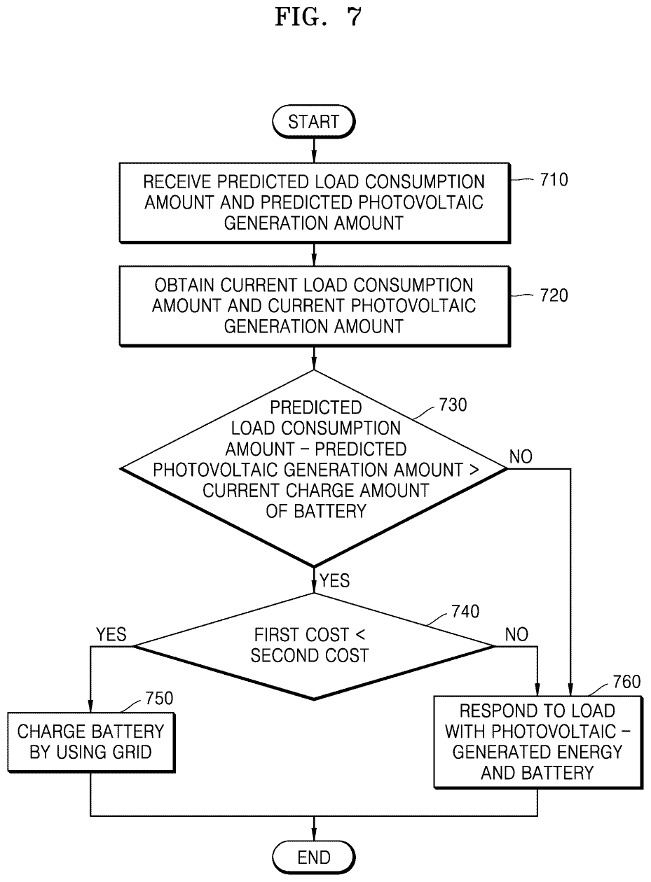

FIG. 7 is a diagram illustrating a method by which an EMS according to an embodiment controls charging and discharging of a battery.

In an embodiment, the processor may be configured to control charging and discharging of a battery based on the plurality of groups and the current charge amount of the battery.

Hereinafter, a detailed method of controlling charging and discharging of a battery based on a plurality of groups and the current charge amount of the battery will be described with reference to operations 710 to 770.

In operation 710, the processor may receive the predicted load consumption amount and the predicted photovoltaic generation amount. For example, detailed descriptions about a method by which the processor performs predictions and the load consumption amount and photovoltaic generation amount generated as a result of performing the prediction have been given above with reference to FIG. 6, and thus are omitted.

In operation 720, the processor may obtain the current load consumption amount and the current photovoltaic generation amount. For example, the processor may obtain the load consumption amount at the time of performing the prediction and the photovoltaic generation amount at the time of performing the prediction.

In an embodiment, the processor may adjust the predicted load consumption amount and the predicted photovoltaic generation amount based on the current load consumption amount and the current photovoltaic generation amount. Accordingly, the processor may obtain a value that adjusts the predicted load consumption amount and a value that adjusts the predicted photovoltaic generation amount. At this time, the value that adjusts the predicted load consumption amount and the value that adjusts the predicted photovoltaic generation amount may be used in operation 730 below.

In operation 730, the processor may determine whether a value obtained by deducting the predicted photovoltaic generation amount from the predicted load consumption amount is greater than the current charge amount of the battery. At this time, the predicted load consumption amount and the predicted photovoltaic generation amount may refer to the load prediction amount and the photovoltaic generation prediction amount described above with reference to FIG. 6.

In some embodiments, the processor may determine whether a value obtained by deducting the value that adjusts the photovoltaic generation amount from the value that adjusts the load consumption amount is greater than the current charge amount of the battery. That is, the processor may perform operation 730 by using a value that adjusts the predicted load consumption amount by reflecting the current load consumption amount and a value that adjusts the predicted photovoltaic generation amount by reflecting the current photovoltaic generation amount.

The processor may perform operation 740 in case that the value obtained by deducting the predicted photovoltaic generation amount from the predicted load consumption amount is greater than the current charge amount of the battery. In some embodiments, the processor may perform operation 740 in case that the value obtained by deducting the value that adjusts the predicted photovoltaic generation amount from the value that adjusts the predicted load consumption amount is greater than the current charge amount of the battery.

In an embodiment, the processor may satisfy the predicted load consumption amount through photovoltaic-generated energy and energy charged to the battery in case that the value obtained by deducting the predicted photovoltaic generation amount from the predicted load consumption amount is equal to or less than the current charge amount of the battery. This may mean that the processor performs operation 760.

In some embodiments, the processor may satisfy the predicted load consumption amount through photovoltaic-generated energy and energy charged to the battery in case that the value obtained by deducting the value that adjusts the predicted photovoltaic generation amount from the value that adjusts the predicted load consumption amount is equal to or less than the current charge amount of the battery. Likewise, this may mean that the processor performs operation 760.

In operation 760, the processor may satisfy the predicted load consumption amount through photovoltaic-generated energy and energy charged in the battery. This may be because, as a result of performing the determination process in operation 730, the amount of energy expected to be consumed by the load in the future is less than the current charge amount of the battery. That is, the processor may be configured to control the battery not to perform charging in case that the amount of energy expected to be consumed by the load in the future is less than the current charge amount of the battery.

In an embodiment, the processor may obtain a first cost incurred in charging the current battery through a grid and a second cost incurred in satisfying the predicted load consumption amount through the grid in the future, based on information about the plurality of groups, in case that the value obtained by deducting the predicted photovoltaic generation amount from the predicted load consumption amount exceeds the current charge amount of the battery. In another embodiment, the processor may be configured to compare the value that adjusts the predicted load consumption amount with the value that adjusts the photovoltaic generation amount. In some embodiments, the processor according to an embodiment may control the battery based on a comparison result between the first cost and the second cost.

In an embodiment, the processor may calculate the first cost and the second cost.

The first cost may refer to a charge incurred in charging the current battery through the grid based on the information about the plurality of groups. In an embodiment, the processor may calculate the first cost based on information about the plurality of groups generated through the method described above with reference to FIGS. 3 to 5. As an example, the processor may determine which of the plurality of groups that a time period having a time point charging a battery through the grid belongs to, and calculate the first cost by referring to the energy unit price in the corresponding group.

The second cost may be a charge incurred to satisfy the predicted future load consumption amount through the grid based on the information about the plurality of groups. In an embodiment, the processor may calculate the second cost based on the information about the plurality of groups generated through the method described above with reference to FIGS. 3 to 5. As an example, the processor may determine which of the plurality of groups that a time point expected to charge the battery belongs to, and calculate the second cost by referring to unit price information about the corresponding group.

In operation 740, the processor may determine whether the first cost is less than the second cost. At this time, the processor may perform operation 750 in case that the first cost is less than the second cost. In some embodiments, the processor may perform operation 760 in case that the first cost is equal to or greater than the second cost.

In an embodiment, the processor may be configured to control charging and discharging of the battery such that the battery performs charging by using the grid, based on the first cost being less than the second cost. For example, the processor may be configured to control the charging and discharging of the battery such that the battery performs charging by using the grid when a time period during which charging is performed corresponds to the third group. This may be according to a result that the processor compares the first cost with the second cost.

In operation 750, the processor may be configured to control the charging and discharging of the battery such that the battery performs charging by using the grid. Accordingly, the processor may be configured to control the charging and discharging of the battery such that the battery performs charging by using the grid only when a charge of performing charging by using the grid is less than a charge corresponding to the predicted load consumption amount with the photovoltaic-generated energy and the energy charged to the battery, thereby enabling the user to save on the electricity charge.

In operation 760, the processor may satisfy the predicted load consumption amount through the photovoltaic-generated energy and energy charged in the battery. For example, the processor may be configured to control the charging and discharging of the battery such that the battery does not perform charging by using the grid, in case that the time period during which charging is performed corresponds to the first group. This may be according to a result that the processor compares the first cost with the second cost. For example, a detailed description of operation 760 is omitted as it has been described above.

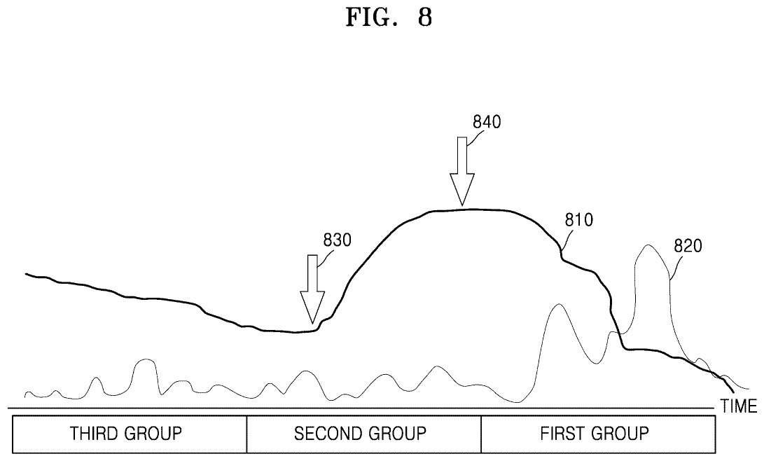

FIG. 8 is a diagram illustrating an EMS according to an embodiment controlling charging and discharging of a battery.

FIG. 8 shows changes in load consumption amount 820 and changes in energy 810 charged to the battery over time. A processor according to an embodiment may control charging and discharging of a battery based on a plurality of groups and the current charge amount of the battery through the processes described above with reference to FIGS. 3 to 7.

For example, the processor may be configured to control the charging and discharging of the battery 830 by considering the pattern of energy 810 charged in the battery and the load consumption amount 820 such that the battery performs charging by using a grid. This may correspond to operation 750 of FIG. 7. For example, a detailed description of the determination process until the processor performs operation 750 is omitted as it has been described above with reference to FIG. 7.

In some embodiments, the processor may be configured to control the battery not to perform charging by using the grid 840 by considering the pattern of energy 810 charged in the battery 810 and the load consumption amount 820. This may correspond to operation 760 of FIG. 7. For example, a detailed description of the determination process until the processor performs operation 760 is omitted as it has been described above with reference to FIG. 7.

The processor may implement a method of controlling charging and discharging of a battery by comprehensively considering time-slot-based rate information, an energy usage pattern of the user, and a photovoltaic generation pattern of a photovoltaic generation system used by the user through the operations described above with reference to FIGS. 3 to 8. Accordingly, the processor may reduce utility charge charged to the user.

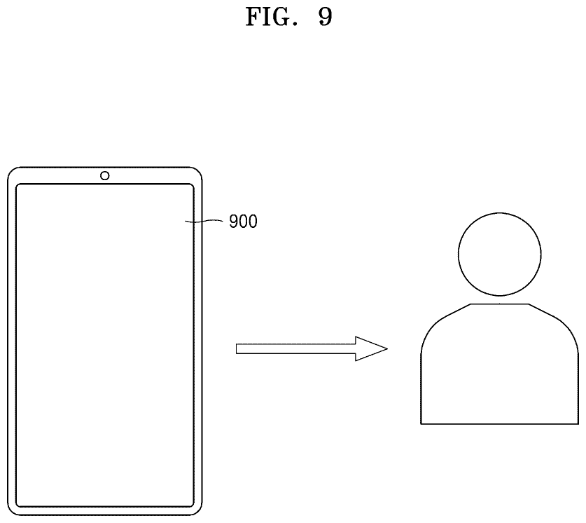

FIG. 9 is a diagram illustrating an interface that an EMS according to an embodiment may provide.

The interface may include a user interface (UI) for providing various types of information to the user. For example, the processor may be configured to provide a screen 900 displaying various types of information as the UI. Hereinafter, examples of various types of information that may be provided to the user through the interface are shown.

In an embodiment, the processor may be configured to provide time-slot-based rate information to the user. For example, the time-slot-based rate information may refer to the time-slot-based rate information described above with reference to FIGS. 3 to 8. For example, the processor may display, on a screen, information about a plurality of groups which are distinguishable from each other and correspond to a plurality of time periods. As an example, the processor may be configured to display and provide, on a screen, an image in which the plurality of time periods included in a day are classified corresponding to information about the plurality of groups.

In an embodiment, the processor may be configured to provide the user with various types of information regarding charge reduction. For example, the processor may be configured to provide the user with an amount of charge expected to be reduced when controlling the charging and discharging of the battery by using the method described above with reference to FIGS. 3 to 8.

In an embodiment, the processor may be configured to provide a notification based on the plurality of groups to the user. For example, the processor may be configured to provide a notification at a time point that the plurality of groups start and/or end. As an example, the processor may be configured to provide a notification regarding that a high charge may be charged based on the start of an on-peak time corresponding to the first group.

In an embodiment, the processor may be configured to provide the user with statistical materials regarding rates. In some embodiments, the processor may be configured to provide statistics on reducing costs. For example, the processor may be configured to provide statistical information regarding a charge expected to be reduced when controlling the charging and discharging of the battery by using the method described above with reference to FIGS. 3 to 8. In some embodiments, the processor may be configured to provide statistical information about seasonal photovoltaic generation prediction amounts and rates expected to be annually reduced.

In an embodiment, the processor may be configured to provide information regarding the state of a battery to the user. For example, the processor may visualize and provide the charge and discharge schedules of the battery. As an example, the processor may visualize and provide the charging schedule and the discharging schedule of the battery when controlling the charging and discharging of the battery with reference to FIGS. 3 to 8.

In some embodiments, the processor may be configured to provide a notification at a time point where the battery is expected to discharge. In some embodiments, the processor may be configured to provide a battery usage expected time based on the current battery charge amount. In some embodiments, the processor may be configured to provide information about the charge cycles and lifespan management of the battery.

In an embodiment, the processor may be configured to provide information about a photovoltaic generation prediction amount. For example, the processor may be configured to provide information obtained by comparing the photovoltaic generation prediction amount with an actual usage amount of the user.

In an embodiment, the processor may be configured to provide information about the weather. For example, the processor may be configured to provide information about the weather along with the photovoltaic generation prediction amount described above with reference to FIG. 6. In some embodiments, the processor may be configured to provide weather information along with a photovoltaic generation prediction amount.

In an embodiment, the processor may be configured to provide monitoring information. For example, the processor may be configured to provide materials including an analysis of power consumption patterns over a particular cycle, a power usage pattern of the user, and a comparison between an actual power usage pattern of the user and a load prediction amount. In some embodiments, the processor may be configured to provide optimization strategies to reduce rates charged to the user.

According to the problem solving means of the disclosure described above, a method and apparatus for controlling charging and discharging of a battery based on time-slot-based rate information about a time-slot-based rate plan used by a user may be provided, thereby increasing user convenience.

The embodiments according to the disclosure described above may be implemented in the form of a computer program that may be executed through various components on a computer, and such a computer program may be recorded on a computer-readable medium.

At this time, the medium may include magnetic media such as hard disks, floppy disks, and magnetic tapes, optical recording media such as compact disc read-only memory (CD-ROM) and digital versatile disc (DVD), magneto-optical media such as floptical disks, and hardware devices specifically configured to store and execute program instructions, such as read-only memory (ROM), random access memory (RAM), flash memory, etc.

For example, the computer program may be specially designed and configured for the disclosure or may be known and available to those skilled in the art of computer software. Examples of computer programs may include not only machine language code, such as that produced by a compiler, but also high-level language code that may be executed by a computer using an interpreter or the like.

The particular implementations described in this disclosure are merely examples and do not limit the scope of the disclosure in any way. For the sake of brevity of the specification, descriptions of conventional electronic components, control systems, software, and other functional aspects of the systems may be omitted. For example, lines connecting or disconnecting between components depicted in the drawings are merely representative of functional connections and/or physical or circuit connections, and may be replaced or represented as various additional functional connections, physical connections, or circuit connections in an actual device. For example, if there is no specific mention of something as “essential”, “importantly”, etc., it may not be an essential component for the application of the disclosure.

The use of the term “above” and similar referential terms in the specification of the disclosure (especially in the claims) may refer to both the singular and the plural. For example, when a range is described in the disclosure, it is included in the disclosure that individual values belonging to the range are applied (unless otherwise stated), and it is the same as describing each individual value constituting the range in the detailed description of the disclosure.

Unless there is a clear description or contradiction of the order of the operations constituting the method according to the disclosure, the operations may be performed in any suitable order. The disclosure is not necessarily limited to the order in which the above operations are described. Any use of examples or example terms (e.g., etc.) in the disclosure is merely to illustrate the disclosure in detail and the scope of the disclosure is not limited by the examples or example terms unless otherwise defined by the claims. Furthermore, those skilled in the art will appreciate that various modifications, combinations and variations may be made within the scope of the appended claims or their equivalents, depending on design conditions and factors.

Therefore, the idea of the disclosure should not be limited to the embodiments described above, and all scopes equivalent to or equivalently modified from the following claims as well as the claims are considered to fall within the scope of the idea of the disclosure.

What is claimed is:

1. A method of controlling charging and discharging of a battery, comprising:
obtaining information about a rate plan to be analyzed;
extracting time-slot-based rate information about the rate plan to be analyzed based on detailed information about the rate plan to be analyzed;
generating a plurality of groups into which a plurality of time periods included in a day are classified, based on the time-slot-based rate information; and
controlling the charging and discharging of the battery based on the plurality of groups and a current charge amount of the battery.

2. The method of claim 1, wherein
the obtaining of the information about the rate plan to be analyzed comprises obtaining information about the rate plan to be analyzed based on a user input, and
the extracting of the time-slot-based rate information about the rate plan to be analyzed comprises
extracting the time-slot-based rate information from the detailed information received from a server.

3. The method of claim 1, wherein
the extracting of the time-slot-based rate information about the rate plan to be analyzed comprises
extracting the time-slot-based rate information based on time-of-use (TOU) information included in the detailed information.

4. The method of claim 1, wherein
the generating of the plurality of groups comprises
classifying the plurality of time periods included in a day into one of a first group, a second group, and a third group, based on a sorting result of the time-slot-based rate information.

5. The method of claim 1, wherein
the controlling of the charging and discharging of the battery comprises
predicting a photovoltaic generation amount and a load consumption amount for a certain time period based on input data comprising a previously performed photovoltaic power generation amount and a power amount previously consumed by a load.

6. The method of claim 5, wherein
the predicting of the photovoltaic generation amount and the load consumption amount is performed by a machine learning model.

7. The method of claim 5, wherein
the controlling of the charging and discharging of the battery comprises:
comparing a value obtained by deducting the predicted photovoltaic generation amount from the predicted load consumption amount with the current charge amount of the battery; and
when the value obtained by deducting the predicted photovoltaic generation amount from the predicted load consumption amount exceeds the current charge amount of the battery, obtaining a first cost incurred in charging a current battery through a grid and a second cost incurred in satisfying the predicted load consumption amount through the grid in a future, based on information about the plurality of groups.

8. The method of claim 5, wherein
the controlling of the charging and discharging of the battery comprises:
comparing a value obtained by deducting the predicted photovoltaic generation amount from the predicted load consumption amount with a current charge amount of the battery; and
when the value obtained by deducting the predicted photovoltaic generation amount from the predicted load consumption amount is equal to or less than the current charge amount of the battery, satisfying the predicted load consumption amount through photovoltaic-generated energy and energy charged to the battery.

9. The method of claim 7, wherein
the controlling of the charging and discharging of the battery comprises controlling the battery based on a comparison result between the first cost and the second cost.

10. A computer-readable recording medium having recorded thereon a program to cause a computer to execute the method of claim 1.

11. An energy management system comprising a processor, wherein the processor is configured to obtain information about a rate plan to be analyzed,
extract time-slot-based rate information about the rate plan to be analyzed based on detailed information about the rate plan to be analyzed,
generate a plurality of groups into which a plurality of time periods included in a day are classified, based on the time-slot-based rate information, and
control charging and discharging of a battery based on the plurality of groups and a current charge amount of the battery.

12. The energy management system of claim 11, wherein
the processor is further configured to obtain information about the rate plan to be analyzed based on a user input, and
extract the time-slot-based rate information from the detailed information received from a server.

13. The energy management system of claim 11, wherein
the processor is further configured to
extract the time-slot-based rate information based on time-of-use (TOU) information included in the detailed information.

14. The energy management system of claim 11, wherein
the processor is further configured to
generate the plurality of groups by classifying the plurality of time periods included in a day into one of a first group, a second group, and a third group, based on a sorting result of the time-slot-based rate information.

15. The energy management system of claim 11, wherein
the processor is further configured to control the charging and discharging of the battery by predicting a photovoltaic generation amount and a load consumption amount for a certain time period based on input data comprising a previously performed photovoltaic power generation amount and a power amount previously consumed by a load.

16. The energy management system of claim 15, wherein
the processor is further configured to make a prediction by using a machine learning model.

17. The energy management system of claim 15, wherein
the processor is further configured to
compare a value, obtained by deducting the predicted photovoltaic generation amount from the predicted load consumption amount, with the current charge amount of the battery, and,
when the value obtained by deducting the predicted photovoltaic generation amount from the predicted load consumption amount exceeds the current charge amount of the battery, control the charging and discharging of the battery by obtaining a first cost incurred in charging the current battery through a grid and a second cost incurred in satisfying the predicted load consumption amount through the grid in a future, based on information about the plurality of groups.

18. The energy management system of claim 15, wherein
the processor is further configured to
compare a value, obtained by deducting the predicted photovoltaic generation amount from the predicted load consumption amount, with the current charge amount of the battery, and,
when the value obtained by deducting the predicted photovoltaic generation amount from the predicted load consumption amount is equal to or less than the current charge amount of the battery, control the charging and discharging of the battery to satisfy the predicted load consumption amount through photovoltaic-generated energy and energy charged to the battery.

19. The energy management system of claim 17, wherein
the processor is further configured to control the battery based on a comparison result between the first cost and the second cost.
